(19) United States
(12) Patent Application Publication
(10) Pub. No.: US 2020/0018585 A1
(43) Pub. Date: Jan. 16, 2020

(54) TAPE MEASURE APPARATUS AND METHOD

(71) Applicants: Nikolay Suvorov, Richmond Hill (CA); Olga Suvorova, Richmond Hill (CA)

(72) Inventors: Nikolay Suvorov, Richmond Hill (CA); Olga Suvorova, Richmond Hill (CA)

(21) Appl. No.: 16/032,463

(22) Filed: Jul. 11, 2018

(51) Int. Cl. G01B 3/10; G01B 3/00

(52) U.S. Cl. CPC G01B 3/1041; G01B 3/004

(57) ABSTRACT

A tape measure apparatus including a housing having a base-wall, a retractable measuring tape disposed within, and a first-set of indicia markings beginning at a first-end of the base-wall and terminating at a second-tape-end of the retractable measuring tape. The first-set of indicia markings comprise of graduated measurements for measuring a distance between two surfaces or objects. The tape measure apparatus is useful for enabling a user to accurately measure the distance without bending or distorting the retractable measuring tape.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of measuring tools of existing art and more specifically relates to an improved measuring scale for a tape measure apparatus.

### RELATED ART

A tape measure or measuring tape is a flexible ruler used to measure distance. Tape measures are generally coiled around an axis with a spring return mechanism to return the flexible ruler into a housing with the axis. A common problem of tape measures is measuring a distance between two or more surfaces or objects. Often, the flexible ruler is required to be bent to accommodate the surfaces or object in order to measure the full distance. Measurements may become distorted or otherwise difficult to read on the flexible ruler. Therefore, a suitable solution is required.

U.S. Pat. No. 8,590,171 to Paul Ricalde relates to a tape measure apparatus with a rotating and sliding catch. The described tape measure apparatus with a rotating and sliding catch includes an improved tape measure apparatus which includes a catch that is both slidable and rotatable relative to the rule blade in a plane which is perpendicular to the longitudinal axis of the rule blade when the rule blade is extended from the tape casing.

### SUMMARY OF THE INVENTION

In view of the foregoing disadvantages inherent in the known measuring tool art, the present disclosure provides a novel tape measure apparatus and method. The general purpose of the present disclosure, which will be described subsequently in greater detail, is to provide a tape measure apparatus and method for improving the measuring of distance between two surfaces.

A tape measure apparatus is disclosed herein. The tape measure apparatus includes a housing including an inner-volume defined by a pair of side-walls, a top-wall, and a base-wall opposite the top-wall. The base-wall may include a first-end, a second-end, and a base-length therebetween.

The tape measure apparatus may further include a tape-hole through the top-wall and near the base-wall. A retractable measuring tape may be disposed within the inner-volume. The retractable measuring tape includes a first-tape-end, a second-tape-end, and a tape-length therebetween. The retractable measuring tape may be configured to selectively extend from the tape-hole between a coiled-position within the inner-volume and an uncoiled-position outside of the inner-volume.

In addition, a first-set of indicia markings may be included beginning at the first-end of the base-wall and terminating at the second-tape-end of the retractable measuring tape. The first-set of indicia markings may allow a user to accurately measure a distance between two surfaces without bending the retractable measuring tape which can cause measurement readings to become distorted.

According to another embodiment, a method of using a tape measure apparatus is also disclosed herein. The method includes providing a tape measure apparatus as described above, extending the retractable measuring tape between the coiled-position within the inner-volume and the uncoiled-position outside of the inner-volume, and measuring a distance between two surfaces via the first-set of measuring indicia with the second-end of the base-wall being a point of measure.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a tape measure apparatus and method, constructed and operative according to the teachings of the present disclosure.

FIG. 1 is a perspective view of the tape measure apparatus during an ‘in-use’ condition, according to an embodiment of the disclosure.

FIG. 2 is a perspective view of the tape measure apparatus of FIG. 1, according to an embodiment of the present disclosure.

FIG. 3 is a top view of the tape measure apparatus of FIG. 1, according to an embodiment of the present disclosure.

FIG. 4 is a side view of the tape measure apparatus of FIG. 1, according to an embodiment of the present disclosure.

FIG. 5 is a flow diagram illustrating a method of using a tape measure apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a measuring tool and more particularly to a tape measure apparatus and method as used to improve the efficiency of measuring of distance between two surfaces.

Generally, the present invention provides a way to accurately measure the distance between two surfaces (or objects). Ordinary measuring tools (i.e. tape measurers) do not provide an accurate measurement between the surfaces, as it needs to be bended at one end, which results with an inaccurate measurement. The present invention may be useful by providing a scale for accurate measurements between the surfaces. Further, a regular scale seen on ordinary measuring tools may be provided for all other measurements.

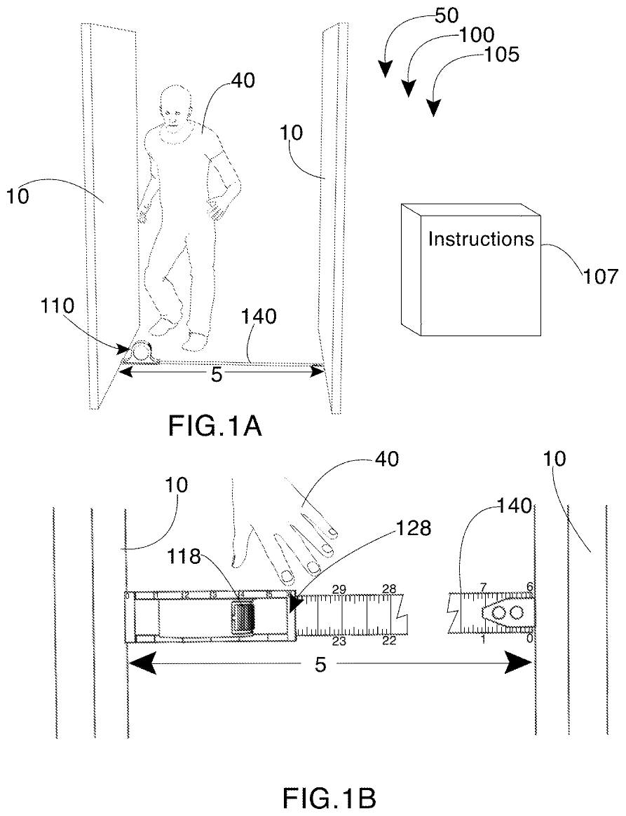

Referring now more specifically to the drawings by numerals of reference, there is shown in FIGS. 1-4, various views of a tape measure apparatus 100.

FIG. 1 shows a tape measure apparatus 100 during an ‘in-use’ condition 50, according to an embodiment of the present disclosure. Here, the tape measure apparatus 100 may be beneficial for use by a user 40 to accurately measure a distance 5 between two surfaces 10 (or objects). As illustrated, the tape measure apparatus 100 may include a housing 110 including an inner-volume 112 defined by a pair of side-walls 114, a top-wall 116, and a base-wall 120 opposite the top-wall 116. The base-wall 120 may include a first-end 122, a second-end 124, and a base-length 126 therebetween.

According to one embodiment, the tape measure apparatus 100 may be arranged as a kit 105. In particular, the tape measure apparatus 100 may further include a set of instructions 107. The instructions 107 may detail functional relationships in relation to the structure of the tape measure apparatus 100 such that the tape measure apparatus 100 can be used, maintained, or the like, in a preferred manner.

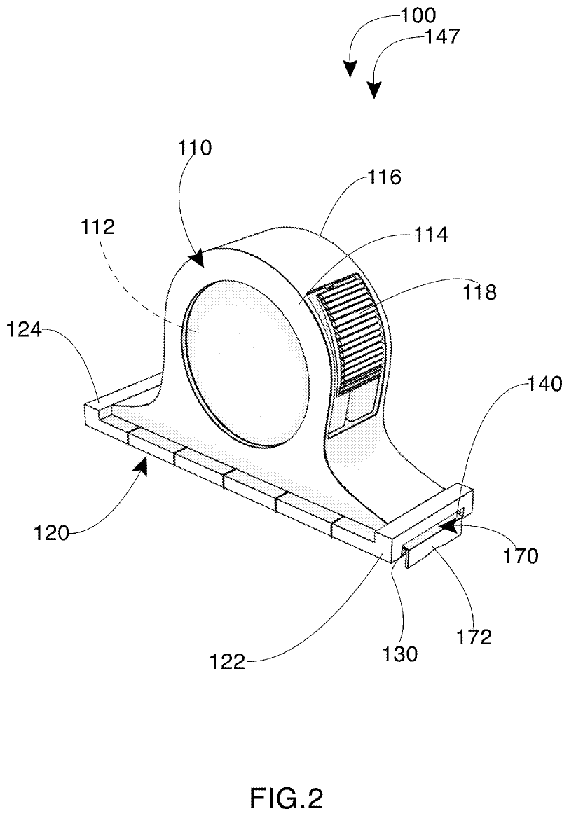

FIG. 2 shows the tape measure apparatus 100 of FIG. 1, according to an embodiment of the present disclosure. As above, the tape measure apparatus 100 may include the housing 110 including the inner-volume 112 defined by the pair of side-walls 114, the top-wall 116, and the base-wall 120 opposite the top-wall 116. The base-wall 120 may include the first-end 122, the second-end 124, and the base-length 126 therebetween.

The tape measure apparatus 100 may further includes a tape-hole 130 through the top-wall 116 and near the base-wall 120. A retractable measuring tape 140 may be disposed within the inner-volume 112. The retractable measuring tape 140 includes a first-tape-end 142, a second-tape-end 144, and a tape-length 146 therebetween. The retractable measuring tape 140 may be configured to selectively extend from the tape-hole 130 between a coiled-position 147 within the inner-volume 112 and an uncoiled-position 149 outside of the inner-volume 112. The retractable measuring tape 140 may be sequentially coiled about an axis such that it can be manipulated from the coiled-position 147 and the uncoiled-position 149.

The retractable measuring tape 140 may further include a tab 170 coupled to the first-tape-end 142. The tab 170 may include an edge 172 configured for hooking onto the surfaces 10 (or objects) in order to hold the tape measure apparatus 100 in place. The edge 172 may be integral to the tab 170 at a 90-degree angle.

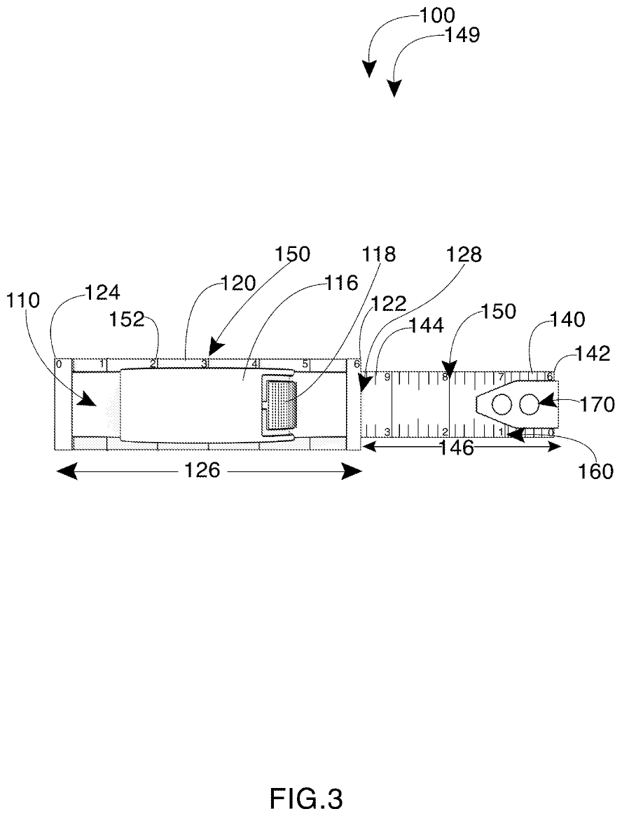

Referring now to FIG. 3, a top view of the tape measure apparatus 100 of FIG. 1, according to an embodiment of the present disclosure. The tape measure apparatus 100 may include a first-set of (functional) indicia markings 150 for accurately measuring distances 5 between the surfaces 10, and a second-set of (functional) indicia markings 160 for all other measurements.

The first-set of indicia markings 150 may begin at the first-end 122 of the base-wall 120 and terminate at the second-tape-end 144 of the retractable measuring tape 140. The first-set of indicia markings 150 may allow the user 40 to accurately measure the distance 5 between the two surfaces 10 without bending the retractable measuring tape 140 which can cause measurement readings to become distorted. Further, the first-set of indicia markings 150 are configured to accurately measure the distance 5 between two surfaces 10 with the second-end 124 of the base-wall 120 being a point of measure 128. The first-set of indicia markings 150 may be disposed linearly along the base-length 126 and the tape-length 146.

The second-set of indicia markings 160 may begin at the first-tape-end 142 and terminate at the second-tape-end 144 of the retractable measuring tape 140. The second-set of indicia markings 160 may be disposed linearly along the tape-length 146.

According to the present embodiment, the first-set of indicia markings 150 and the second-set of indicia markings 160 may be disposed on opposite sides of the retractable measuring tape 140. In addition, the first-set of indicia markings 150 and the second-set of indicia markings 160 may comprise of graduated measurements 152. The graduated measurements 152 may include units of inches and centimeters, and fractions thereof. In other embodiments, the graduated measurements 152 may include units of length according to other known systems (i.e. feet).

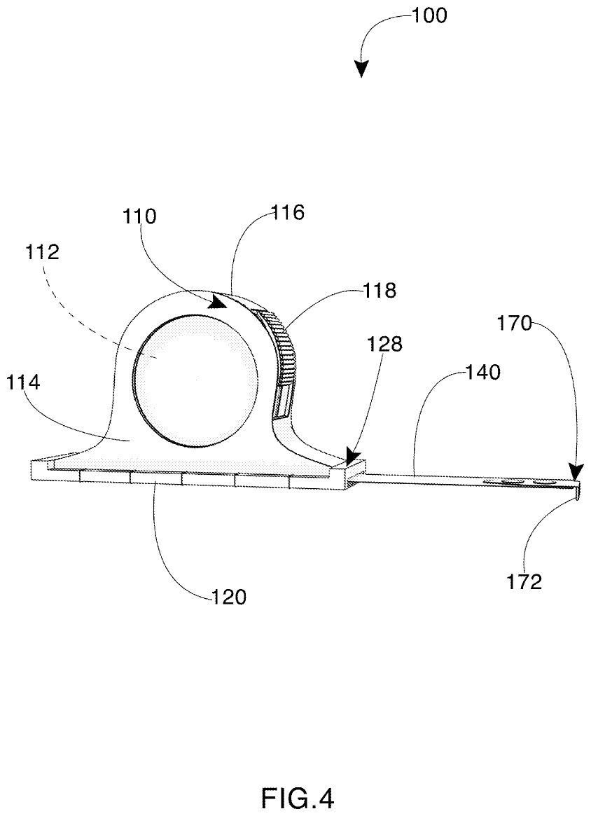

FIG. 4 is a side view of the tape measure apparatus 100 of FIG. 1, according to an embodiment of the present disclosure. The housing 110 includes the inner-volume 112 defined by the pair of side-walls 114, the top-wall 116, and the base-wall 120 opposite the top-wall 116. The base-wall 120 may include the first-end 122, the second-end 124, and the base-length 126 therebetween. The base-length 126 (FIG. 3) may be larger than a length associated with the pair of side-walls 114 and the top-wall 116. As shown, the top-wall 116 may extend downwardly towards the base-wall 120 on both ends. It should be apparent, however, that the housing 110 may take any shape requiring the use of more or less walls with the first-set of measuring indicia 150 being along one wall thereof.

The housing 110 may further include a lock-mechanism 118 configured to selectively lock the retractable measuring tape 140 in a plurality of uncoiled-positions. Preferably, the housing 110 is substantially rigid and comprised of rigid material such as metal or hard plastic.

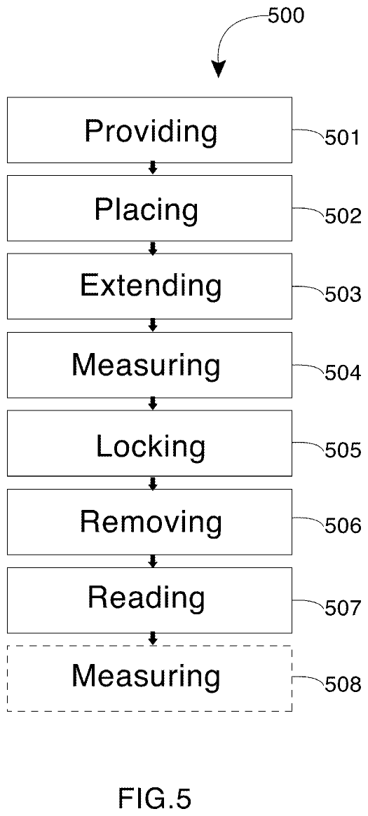

Referring now to FIG. 5 showing a flow diagram illustrating a method for using 500 a tape measure apparatus 100, according to an embodiment of the present disclosure. In particular, the method for using 500 the tape measure apparatus 100 may include one or more components or features of the tape measure apparatus 100 as described above. As illustrated, the method for using 500 the tape measure apparatus 100 may include the steps of: step one 501, providing a tape measure apparatus 100 comprising a housing 110 including an inner-volume 112 defined by a pair of side-walls 114, a top-wall 116, and a base-wall 120 opposite the top-wall 116, the base-wall 120 including a first-end 122, a second-end 124, and a base-length 126 therebetween. The housing 110 further including a tape-hole 130 through the top-wall 116 and near the base-wall 120 with a retractable measuring tape 140 disposed within the inner-volume 112. The retractable measuring tape 140 includes a first-tape-end 142, a second-tape-end 144, and a tape-length 146 therebetween, and wherein the retractable measuring tape 140 is configured to selectively extend from the tape-hole 130 between a coiled-position 147 within the inner-volume 112 and an uncoiled-position 149 outside of the inner-volume 112. The tape measure apparatus 100 further including a first-set of indicia markings 150 beginning at the first-end 122 of the base-wall 120 and terminating at the second-tape-end 144 of the retractable measuring tape 140; step two 502, extending the retractable measuring tape 140 between the coiled-position 147 within the inner-volume 112 and the uncoiled-position 149 outside of the inner-volume 112; step three 503, measuring a distance 5 between two surfaces 10 via the first-set of measuring indicia 150 with the second-end 124 of the base-wall 120 being a point of measure 128; and step four 504, measuring the distance 5 via a second-set of measuring indicia 160.

It should be noted that step four 504 is an optional step and may not be implemented in all cases. Optional steps of method of use 500 are illustrated using dotted lines in FIG. 5 so as to distinguish them from the other steps of method of use 500. Those with ordinary skill in the art will now appreciate that upon reading this specification and by their understanding the art of measuring lengths and distances as described herein, methods of using the tape measure apparatus 100 will be understood by those knowledgeable in such art. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the first-set of measuring indicia 150 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tape measure apparatus comprising:
a housing including an inner-volume defined by a pair of side-walls, a top-wall, and a base-wall opposite the top-wall, the base-wall including,
a first-end,
a second-end, and
a base-length therebetween,
a tape-hole through the top-wall and near the base-wall;
a retractable measuring tape disposed within the inner-volume, the retractable measuring tape including a first-tape-end, a second-tape-end, and a tape-length therebetween, and wherein the retractable measuring tape is configured to selectively extend from the tape-hole between a coiled-position within the inner-volume and an uncoiled-position outside of the inner-volume; and
a first-set of indicia markings beginning at the first-end of the base-wall and terminating at the second-tape-end of the retractable measuring tape.

2. The tape measure apparatus of claim 1, further comprising a second-set of indicia markings beginning at the first-tape-end and terminating at the second-tape-end of the retractable measuring tape.

3. The tape measure apparatus of claim 2, wherein the second-set of indicia markings are disposed linearly along the tape-length.

4. The tape measure apparatus of claim 3, wherein the first-set of indicia markings and the second-set of indicia markings are disposed on opposite sides of the retractable measuring tape.

5. The tape measure apparatus of claim 4, wherein the first-set of indicia markings and the second-set of indicia markings comprise of graduated measurements.

6. The tape measure apparatus of claim 5, wherein the graduated measurements include units of inches, and fractions thereof.

7. The tape measure apparatus of claim 5, wherein the graduated measurements include units of centimeters, and fractions thereof.

8. The tape measure apparatus of claim 1, wherein the first-set of indicia markings are configured to accurately measure a distance between two surfaces with the second-end of the base-wall being a point of measure.

9. The tape measure apparatus of claim 1, wherein the first-set of indicia markings are disposed linearly along the base-length and the tape-length.

10. The tape measure apparatus of claim 1, wherein the housing further includes a lock-mechanism configured to selectively lock the retractable measuring tape in a plurality of uncoiled-positions.

11. The tape measure apparatus of claim 1, wherein the retractable measuring tape is sequentially coiled about an axis such that it can be manipulated from the coiled-position and the uncoiled-position.

12. The tape measure apparatus of claim 1, wherein the retractable measuring tape includes a tab coupled to the first-tape-end.

13. The tape measure apparatus of claim 1, wherein the tab includes an edge configured for hooking onto surfaces.

14. The tape measure apparatus of claim 1, wherein the base-length is larger than a length associated with the pair of side-walls and the top-wall.

15. The tape measure apparatus of claim 1, wherein the top-wall extends downwardly towards the base-wall on both ends.

16. The tape measure apparatus of claim 1, wherein the housing is substantially rigid.

17. A tape measure apparatus comprising:
a housing including an inner-volume defined by a pair of side-walls, a top-wall, and a base-wall opposite the top-wall, the base-wall including,
a first-end,
a second-end, and
a base-length therebetween,
a tape-hole through the top-wall and near the base-wall;
a retractable measuring tape disposed within the inner-volume, the retractable measuring tape including a first-tape-end, a second-tape-end, and a tape-length therebetween, and wherein the retractable measuring tape is configured to selectively extend from the tape-hole between a coiled-position within the inner-volume and an uncoiled-position outside of the inner-volume; and
a first-set of indicia markings beginning at the first-end of the base-wall and terminating at the second-tape-end of the retractable measuring tape.
further comprising a second-set of indicia markings beginning at the first-tape-end and terminating at the second-tape-end of the retractable measuring tape;
wherein the second-set of indicia markings are disposed linearly along the tape-length;
wherein the first-set of indicia markings and the second-set of indicia markings are disposed on opposite sides of the retractable measuring tape;
wherein the first-set of indicia markings and the second-set of indicia markings comprise of graduated measurements;
wherein the graduated measurements include units of inches, and fractions thereof;
wherein the first-set of indicia markings are configured to accurately measure a distance between two surfaces with the second-end of the base-wall being a point of measure;
wherein the first-set of indicia markings are disposed linearly along the base-length and the tape-length;
wherein the housing further includes a lock-mechanism configured to selectively lock the retractable measuring tape in a plurality of uncoiled-positions;
wherein the retractable measuring tape is sequentially coiled about an axis such that it can be manipulated from the coiled-position and the uncoiled-position;
wherein the retractable measuring tape includes a tab coupled to the first-tape-end;
wherein the tab includes an edge configured for hooking onto surfaces;
wherein the base-length is larger than a length associated with the pair of side-walls and the top-wall; and
wherein the top-wall extends downwardly towards the base-wall on both ends.

18. The tape measure apparatus of claim 17, further comprising set of instructions; and
wherein the tape measure apparatus is arranged as a kit.

19. A method of using a tape measure apparatus, the method comprising the steps of:
providing a tape measure apparatus comprising:
a housing including an inner-volume defined by a pair of side-walls, a top-wall, and a base-wall opposite the top-wall, the base-wall including,
a first-end,
a second-end, and
a base-length therebetween,
a tape-hole through the top-wall and near the base-wall;
a retractable measuring tape disposed within the inner-volume, the retractable measuring tape including a first-tape-end, a second-tape-end, and a tape-length therebetween, and wherein the retractable measuring tape is configured to selectively extend from the tape-hole between a coiled-position within the inner-volume and an uncoiled-position outside of the inner-volume; and
a first-set of indicia markings beginning at the first-end of the base-wall and terminating at the second-tape-end of the retractable measuring tape,
extending the retractable measuring tape between the coiled-position within the inner-volume and the uncoiled-position outside of the inner-volume, and measuring a distance between two surfaces via the first-set of measuring indicia with the second-end of the base-wall being a point of measure.

20. The method of claim 19, further comprising the steps of
measuring the distance via a second-set of measuring indicia.
